(19) United States
(12) Patent Application Publication
(10) Pub. No.: US 2002/0023137 A1
(43) Pub. Date: Feb. 21, 2002

(54) Data telegram for transmitting data formatted in accordance with an extraneous standard

(76) Inventors: Frank Bahren, Karlsruhe (DE); Joachim Wietzke, Karlsruhe (DE); Harald Schopp, Ettlingen (DE); Joachim Bischoff, Keltern (DE); Dirk Lappe, Karlsruhe (DE)

Correspondence Address: Samuels, Gauthier & Stevens LLP, 225 Franklin Street, Suite 3300, Boston, MA, 02110, US

(21) Appl. No.: 09/892,784

(22) Filed: Jun. 27, 2001

(30) Foreign Application Priority Data
Jun. 28, 2000 (DE) 100 30 521.0

(51) Int. Cl. G06F 15/16

(52) U.S. Cl. 709/206; 709/236

(57) ABSTRACT

To design a network, e.g. an MOST network, so that it can also process data telegrams of other standards, the header section (A) of the data telegram, formatted in accordance with the standard of the network or in accordance with another standard, contains standard information, which specifies that the remaining section (B, C) of the data telegram is formatted in accordance with a second standard (TCP/IP), and also specifies this standard.

The invention relates to a method for the transmission of data in a network by means of data telegrams as well as to a data telegram for transmitting data in a network.

In networks which link data sources, data sinks, and transceivers, data are transmitted by means of data telegrams which are formatted in accordance with standards or protocols, e.g. in frames and blocks of various lengths. However, data which do not correspond to the standard of a network cannot be transmitted in this network by means of data telegrams. For example, the MOST standard defines the format for data telegrams by means of which data are transmitted in a multimedia system designed in accordance with the MOST standard. MOST multimedia systems have been developed for use in motor vehicles. The abbreviation MOST stands for Media Oriented Systems Transport or Media Oriented Synchronous Transfer.

Due to the different standards and protocols for data telegrams, e.g., in an MOST multimedia system of a motor vehicle, data cannot be transmitedt by means of data telegrams which are formatted according to the transmission control protocol—abbreviated TCP—or according to the Internet protocol—abbreviated IP—which are prescribed for the Internet.

It is therefore the object of the invention to design a method for transmitting data in a network by means of data telegrams and to design a data telegram for transmitting data in a network, in such a way that data can be transmitted in this network by means of data telegrams which do not correspond to the standard of this network.

In terms of method, this object is achieved by the characteristics of claim 1, in that a defined place in the header section of a data telegram contains standard information which specifies that the remaining section of the data telegram is formatted according to a prescribable standard, and also specifies this standard, and that the prescribable standard is defined in the network.

A data telegram achieves this object with the characteristics specified in claim 2, in that a defined place (4) in the header section (A) of the data telegram contains standard information which specifies that the remaining section (B, C) of the data telegram is formatted according to a prescribable standard, and also specifies this standard.

According to the invention, a defined place in the header section of the data telegram contains standard information which specifies that the remaining part of the data telegram is formatted in accordance with a prescribable standard, and which specifies this standard. From this standard information, the devices linked in the network—e.g. data sources, data sinks, and transceivers—will therefore recognize the standard according to which the received data telegram is formatted, and will therefore be able to receive, transmit, and analyze data telegrams with a standard extraneous to this network.

The header section of the data telegram can be formatted according to the standard of the network or according to another standard.

The inventive method and the inventive data telegram thus make it possible, for example, in an MOST multimedia system installed in a motor vehicle, to use not only MOST telegrams but also data telegrams formatted in accordance with a different standard, such as e.g. the Internet protocols TCP and IP. The invention thus makes it possible for an MOST network to communicate with the Internet without this requiring great technical complexity. An MOST multimedia system in which the inventive method is implemented and in which data can be transmitted in accordance with the inventive data telegram consequently is not limited to the use of MOST telegrams for data transmission, but is compatible with other data telegrams.

The invention will now be described and elucidated in terms of the figures.

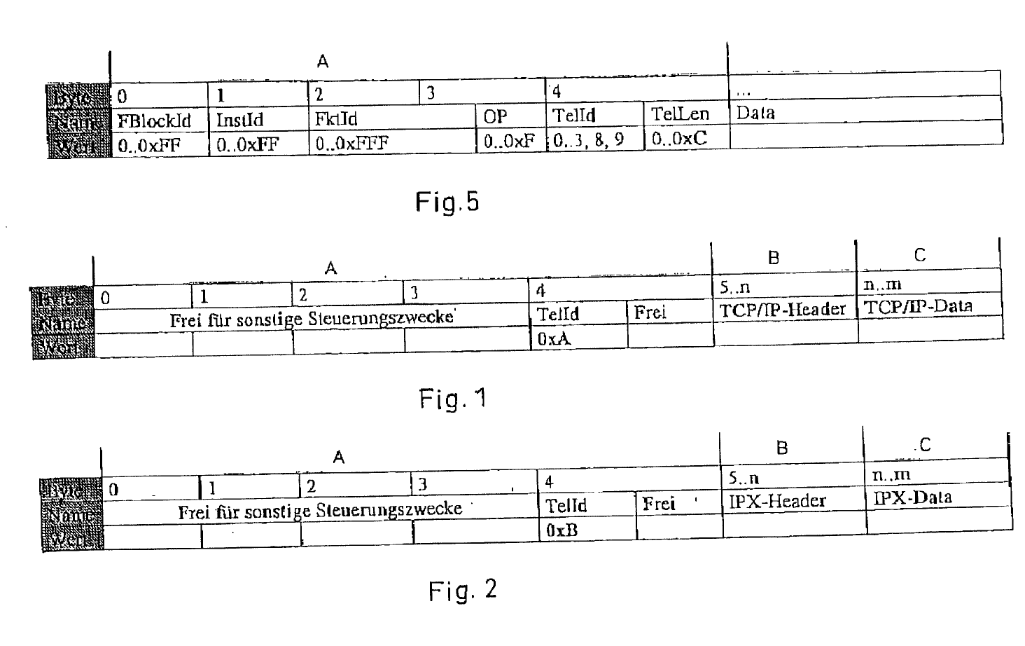

FIG. 1 shows a first embodiment,

FIG. 2 shows a second embodiment,

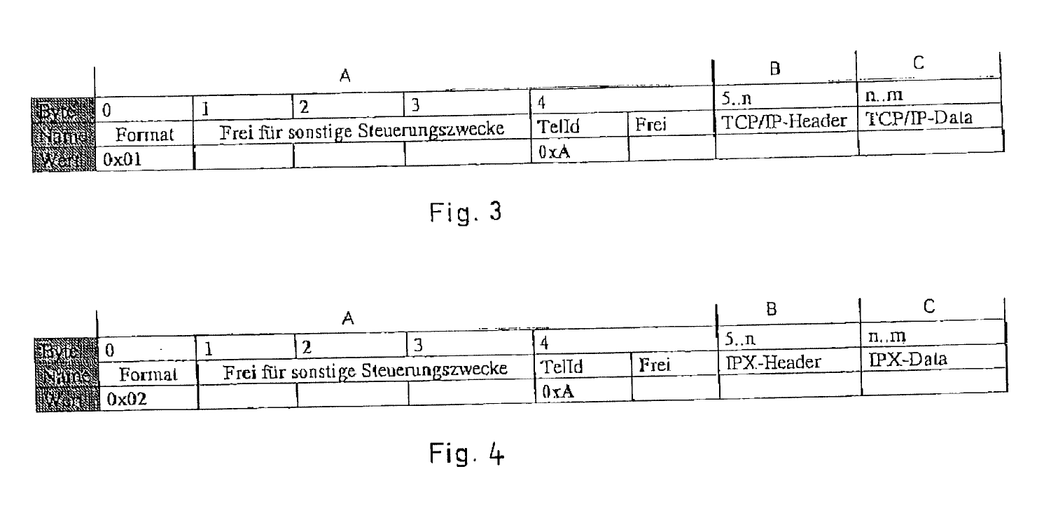

FIG. 3 shows a third embodiment,

FIG. 4 shows a fourth embodiment of an inventive data telegram, and

FIG. 5 shows an MOST telegram.

FIG. 5 shows the format of an MOST telegram. The header section A of the MOST telegram is composed of five bytes 0, 1, 2, 3, and 4. The first byte 0 specifies the function block identification, the second byte 1 specifies the state identification, the third and fourth bytes 2 and 3 specify the function identification, and the fifth byte 4 specifies the telegram identification and the telegram length. The transmitted data follow the fifth byte 4.

FIG. 1 shows a first embodiment of an inventive data telegram. This is a data telegram, whose header section A corresponds to the MOST protocol or standard. The first four bytes 0, 1, 2, and 3 are reserved for control signals. The fifth byte 4 contains the special standard information. In the first embodiment, this specifies that the remaining part of the data telegram is formatted in accordance with the TCP/IP protocol. The remaining part following the header section A is divided into two sections B and C. Section B contains the data belonging to the TCP/IP header, while section C contains the transmitted data.

FIG. 2 shows a second embodiment of an inventive data telegram, whose header section A corresponds to the MOST protocol. As in the preceding embodiment, the fifth byte 4 contains the standard information. Section B contains data belonging to an IPX header; the following section C contains the transmitted data in the IPX format.

FIG. 3 shows a third embodiment of an inventive data telegram, whose header section A likewise corresponds to the MOST protocol. The fifth byte 4 contains the standard information. Section B again contains data of the TCP/IP header. The following section C contains the transmitted data.

FIG. 4 shows a fourth embodiment of an inventive data telegram, whose header section A likewise corresponds to the MOST protocol. The fifth byte 4 contains the standard information. Section B is reserved for data of the IPX header, while section C contains the transmitted data.

The difference between the first embodiment and the third embodiment as well as the second and the fourth embodiment is that a value is associated with byte 0 in the third and fourth embodiment.

However, the inventive method and the inventive data telegram are in no way limited to application in an MOST network. They can be used universally in networks of arbitrary structure and arbitrary standards.

FIG. 1

Byte

Name; Available for other control purposes; Tel Id; Available; TCP/IP header; TCP/IP data

Value

FIG. 2

Byte

Name; Available for other control purposes; Tel Id; Available; IPX header; IPX data

Value

FIG. 3

Byte

Name; Format; Available for other control purposes; Tel Id; Available; TCP/IP header; TCP/IP data

Value

FIG. 4

Byte

Name; Format; Available for other control purposes; Tel Id; Available; IPX header; IPX data

Value

FIG. 5

Byte

Name; F block Id; Inst Id; Fun. Id; OP; Tel Id, Tel Len; Data

### LIST OF REFERENCE SYMBOLS

A Header section

B Section

C Section

0 First byte

1 Second byte

2 Third byte

3 Fourth byte

4 Fifth byte

1. A method for transmitting data in a network by means of data telegrams, characterized in that a defined place (4) in the header section (A) of a data telegram contains standard information which specifies that the remaining section (B, C) of the data telegram is formatted according to a prescribable standard, and also specifies this standard, and that the prescribable standard is defined in the network.

2. A data telegram for transmitting data in a network,
characterized in that a defined place (4) in the header section (A) of the data telegram contains standard information which specifies that the remaining section (B, C) of the data telegram is formatted according to a prescribable standard, and also specifies this standard.

3. The method and data telegram of claims 1 and 2,
characterized in that the standard information is contained in a place (4) in the header section (A), which is unoccupied or which is reserved for non-relevant information.

4. The method or data telegram of claims 1, 2, or 3,
characterized in that the data telegram is divided into frames, the frames into blocks, and the blocks into bytes.

5. The data telegram of claim 2,
characterized in that this data telegram is an MOST telegram, whose header section (A) consists of five bytes (0, 1, 2, 3, 4), and that the standard information is contained in the last byte (4) of the header section (A).

6. The method of claim 1,
characterized in that the network is an MOST network in which data are transmitted by means of MOST telegrams whose header section (A) consists of five bytes (0, 1, 2, 3, 4), and that the standard information is contained in the last byte (4) of the header section (A).

7. The method or data telegram of one of the preceding claims 1 to 6, characterized in that the prescribable standard, according to which the data telegram is formatted, corresponds to the Transmission Control Protocol—abbreviated TCP.

8. The method or data telegram of one of the preceding claims 1 to 6, characterized in that the prescribable standard, according to which the data telegram is formatted, corresponds to the Internet Protocol—abbreviated IP.

9. The method or data telegram of one of the preceding claims 1 to 6, characterized in that the prescribable standard, according to which the data telegram is formatted, corresponds to the Internet Packet Exchange protocol—abbreviated IPX.

10. The method or data telegram of one of the claims 1 to 9, characterized in that the header section (A) of the data telegram is formatted in accordance with the standard of the network.
